(19) United States
(12) Patent Application Publication
(10) Pub. No.: US 2003/0091265 A1
(43) Pub. Date: May 15, 2003

(54) Optical component having a light distribution component with an index of refraction tuner

(76) Inventors: Wenhua Lin, Pasadena, CA (US); Trenton Gary Coroy, Rancho Cucamonga, CA (US)

Correspondence Address: Travis Todd, 2490 Heyneman Hollow, Fallbrook, CA, 92028, US

(21) Appl. No.: 09/993,337

(22) Filed: Nov. 13, 2001

(51) Int. Cl. G02B 6/26; G02B 6/34

(52) U.S. Cl. 385/15; 385/27; 385/39; 385/37

(57) ABSTRACT

An optical component is disclosed. The optical component includes a light distribution component having a light signal carrying region. The component also includes an index tuner configured to tune the index of refraction of the light signal carrying region so as to generate a functional region in the light signal carrying region. The functional region is generated such that the index of refraction of the light signal carrying region is different inside of the functional region and outside of the functional region. In some instances, the index tuner is configured to generate the functional region such that a dispersion profile of the light signal changes in response to traveling through the functional region.

### RELATED APPLICATIONS

This application is related to U.S. patent application Ser. No. 09/924,403 filed on Aug. 6, 2001; entitled “Optical Component Having a Light Distribution Component with a Functional Region”, which is incorporated herein in its entirety.

### BACKGROUND

1. Field of the Invention

The invention relates to one or more optical networking components. In particular, the invention relates to tunable optical components.

2. Background of the Invention

Optical networks include optical fibers that carry light signals to a variety of optical components. Each light signal typically includes a distribution of wavelengths. Different wavelengths tend to travel along the optical fibers at different speeds. As a result, the light signal tends to disperse as the light signal travels along the optical fiber. Significant levels of dispersion can affect the performance of the optical network.

For the above reasons, there is a need for optical components that compensate for and/or correct the effects of dispersion.

### SUMMARY OF THE INVENTION

The invention relates to an optical component. The optical component includes a light distribution component having a light signal carrying region. The component also includes an index tuner configured to tune the index of refraction of the light signal carrying region so as to generate a functional region in the light signal carrying region. The functional region is generated such that the index of refraction of the light signal carrying region is different inside of the functional region and outside of the functional region.

In some instances, the index tuner is configured to generate the functional region such that a dispersion profile of the light signal changes in response to traveling through the functional region. The index tuner can be configured to generate a functional region such that the dispersion profile of the light signal narrows or broadens in response to traveling through the functional region. The index tuner can be configured to generate a functional region such that the dispersion slope of the light signal increases or decreases in response to traveling through the functional region.

In some instances, the optical component includes an array waveguide grating having a plurality of array waveguides in optical communication with the light distribution component such that each array waveguide is configured to carry a portion of the light signal. The array waveguides are arranged so as to combine the portions of the light signal into an output light signal traveling away from the array waveguides at an angle. The index tuner is configured such that tuning of the index tuner changes the angle at which the light signals travel away from the array waveguides.

In one embodiment of the invention, the component also includes an array waveguide grating having a plurality of array waveguides in optical communication with the light distribution component such that the light signal carrying region extends through the array waveguides. Each array waveguide is configured to carry a portion of the light signal. At least a portion of the array waveguides are associated with a path through the light distribution component in that the portion of the light signal traveling through an array waveguide also travels along the associated path. Each path through the functional region is associated with a path index j. The index tuner is positioned such that a portion of each path is adjacent to the index tuner.

In some instances, the length of the portion of the index tuner positioned adjacent to path j includes one or more exponential functions having a base that is a function of the path index, j. The exponential function can include β(j+C)^{α} where C, α and β each being constants.

In some instances, the length of the portion of the index tuner positioned adjacent to path j includes a linear function of the array waveguide index j. The linear function can include j ΔL where ΔL is a constant.

The invention also relates to a method of operating an optical component. The method includes directing a light signal through a light distribution component. The method also includes tuning an index of refraction of a portion of the light distribution component such that a dispersion profile of the light signal changes in response to the light signal being directed through the light distribution component.

The index of refraction can be tuned so as to narrow or broaden the dispersion profile of the light signal. Additionally or alternatively, the index of refraction can be tuned so as to increase or decrease the dispersion slope of the light signal

The invention also relates to a method of fabricating an optical component. The method includes forming a light distribution component in a light transmitting medium positioned on a base. The light distribution component is formed so as to have a light signal carrying region defined in the light transmitting medium. The method also includes forming an index tuner adjacent to the light distribution component. The index tuner is configured to tune the index of refraction of a portion of the light distribution component so as to form a functional region in the light signal carrying region.

### BRIEF DESCRIPTION OF THE FIGURES

FIG. 1A illustrates an embodiment of an optical component. The optical component includes an input light distribution component with an index tuner. The index tuner is configured to provide the optical component with tunable functionality such as demultiplexing functionality and/or dispersion compensating functionality.

FIG. 1B illustrates the optical component having an output light distribution component with an index tuner.

FIG. 1C illustrates the optical component having an input light distribution component with an index tuner. The input light distribution component includes ports located in an input side and an output side. The index tuner is spaced apart from the ports.

FIG. 1D illustrates the optical component including more than one index tuner.

FIG. 2A illustrates operation of an input light distribution component.

FIG. 2B illustrates operation of an output light distribution component.

FIG. 2C illustrates the location of light signal paths adjacent to an index tuner.

FIG. 3A shows the dispersion profile of a light signal before the light signal enters a functional region generated by an index tuner.

FIG. 3B shows the dispersion profile of the light signal after the light signal exits the functional region. The functional region is constructed such that the dispersion profile is narrower after exiting the functional region than before entering the functional region.

FIG. 3C shows the dispersion profile of a light signal before the light signal enters a functional region generated by an index tuner.

FIG. 3D shows the dispersion profile of the light signal after the light signal exits the functional region. The functional region is constructed such that the dispersion profile is broader after exiting the functional region than before entering the functional region.

FIG. 3E shows the dispersion profile of a light signal before the light signal enters a functional region generated by an index tuner.

FIG. 3F shows the dispersion profile of the light signal after the light signal exits the functional region. The functional region is constructed such that the dispersion profile of FIG. 3F has positive dispersion slope relative to the dispersion profile shown in FIG. 3E.

FIG. 3G shows the dispersion profile of a light signal before the light signal enters a functional region generated by an index tuner.

FIG. 3H shows the dispersion profile of the light signal after the light signal exits the functional region. The functional region is constructed such that the dispersion profile of FIG. 3H has negative dispersion slope relative to the dispersion profile shown in FIG. 3G.

FIG. 4A illustrates an optical component having a single light distribution component.

FIG. 4B illustrates another embodiment of an optical component having a single light distribution component.

FIG. 5A illustrates a suitable construction for an optical component having an index tuner configured to generate a functional region. The optical component includes a light transmitting medium positioned on a base.

FIG. 5B is a top view of an optical component having a light distribution component with an index tuner.

FIG. 5C is a cross section of the optical component in FIG. 5B taken at any of the lines labeled A.

FIG. 5D is a cross section of an optical component constructed with a light transmitting medium positioned on a base. A cladding layer is positioned on the light transmitting medium.

FIG. 5E illustrates a suitable construction of an optical component having a mirror.

FIG. 5F is a cross section of an index tuner.

FIG. 5G illustrates the index tuner of FIG. 5F engaged so as to change the index of refraction in a functional region.

FIG. 5H illustrates an index tuner engaged so as to produce a larger change in index of refraction than is produced in FIG. 5F.

FIG. 6A is a top view of an optical component having an index tuner constructed from electrical contacts.

FIG. 6B is a cross section of an optical component having an index tuner constructed from electrical contacts.

FIG. 6C is a cross section of an optical component having an index tuner constructed from electrical contacts. The electrical contacts have different sizes.

FIG. 7A illustrates an optical component having a base with a light barrier positioned over a substrate.

FIG. 7B illustrates an optical component having a base having a light barrier with a surface positioned between sides. A waveguide is formed over the surface and a light transmitting medium is positioned adjacent to the sides.

FIG. 8A through FIG. 8F illustrate a method for forming a component having a light distribution component with a functional region.

### DETAILED DESCRIPTION

The invention relates to an optical component having a tunable functionality. For instance, the optical component can be constructed to have tunable demultiplexing functionality and/or tunable dispersion compensation functionality. The optical component includes a light distribution component having a light signal carrying region for carrying light signals to be processed by the optical component. The light distribution component includes an index tuner configured to tune the index of refraction of the light signal carrying region such that a functional region is generated in the light distribution component.

The index tuner generates the functional region with a shape that provides the optical component with the desired functionality. For instance, the functional region can be shaped so as to change the dispersion profile of a light signal passing through the functional region. The dispersion profile is the intensity versus time profile of the light signal. The shape of the index tuner can be selected so as to generate a functional region that narrows (or broadens) the dispersion profile of a light signal passing through the functional region. Further, the index tuner can be tuned so as to tune the degree of narrowing or broadening that occurs. The shape of the index tuner can be selected so as to generate a functional region that increases (or decreases) the dispersion slope of a light signal passing through the functional region. Further, the index tuner can be tuned so as to tune the degree of dispersion slop change that occurs. As a result, the optical component can be tuned so as to output a light signal having a selected dispersion profile.

Because the dispersion profile of the light signals can be tuned, the optical component can be used to correct for the effects of dispersion on optical networks. For instance, an optical component configured to convert an input light signal to an output light signal having a narrower intensity versus time profile can be positioned before optical components that require narrow intensity versus time profiles. Alternatively, a dispersion compensator configured to convert an input light signal to an output light signal having a narrower intensity versus time profile can be positioned before long optical fiber runs to compensate for the dispersion that occurs during the optical fiber run.

In some instances, the index tuner generates the functional region with a shape that provides a demultiplexing function. The demultiplexing function causes the optical component to direct output light signals having different wavelengths to different output waveguides. Different channels of an optical network are typically carried on light signals having different wavelengths. The demultiplexing functionality allows the index tuner to be tuned so as to change the channels that appear on the output waveguides or to make a particular channel appear on a particular output waveguide.

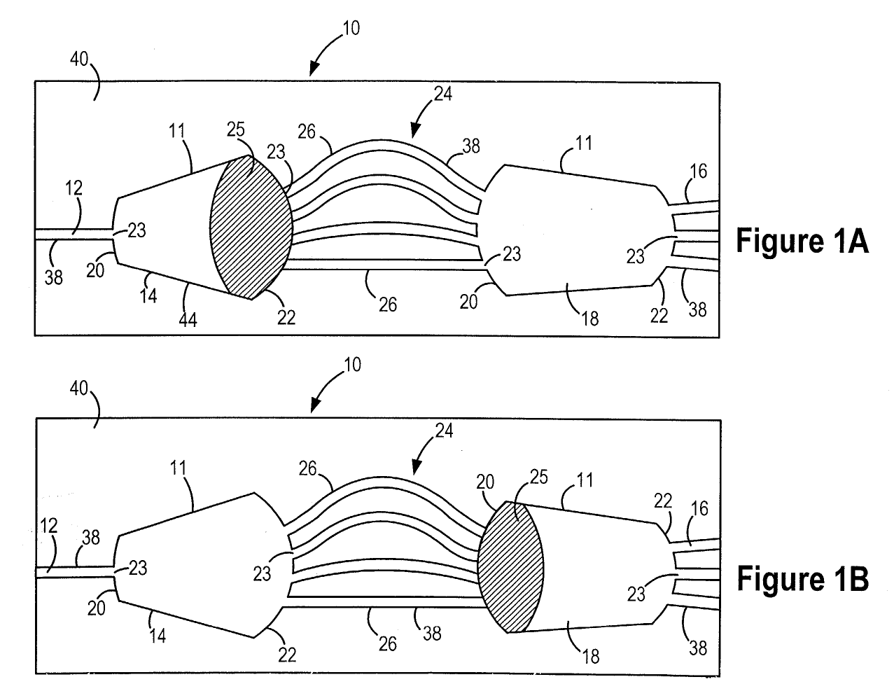

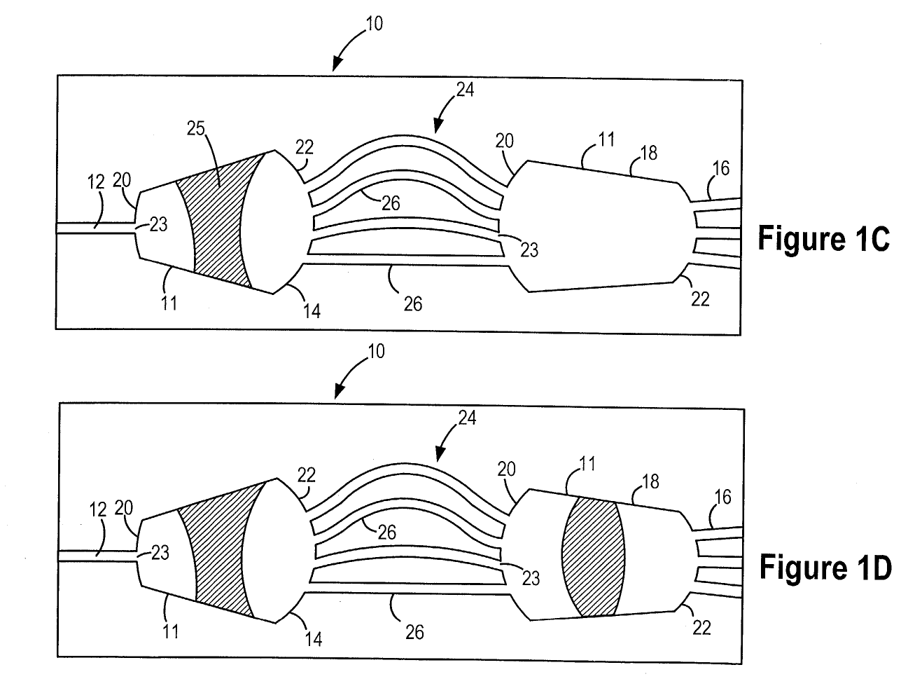

FIG. 1A illustrates an embodiment of an optical component 10 according to the present invention. The optical component 10 includes a plurality of light distribution components 11. For instance, the optical component 10 includes at least one input waveguide 12 in optical communication with an input light distribution component 14 and a plurality of output waveguides 16 in optical communication with an output light distribution component 18. The light distribution components 11 each have an input side 20 and an output side 22. Further, the input side 20 and the output side 22 each have one or more ports 23 through which a light signal or portions of a light signal enter or exit the light distribution component 11. The light distribution components 11 are configured to distribute a light signal from one or more ports 23 on the input side 20 to one or more ports 23 on the output side 22. For instance, a light distribution component can be configured to distribute a light signal from one port 23 on the input side 20 to a plurality of ports 23 on the output side 22 or from a plurality of ports 23 on the input side 20 to a single port 23 on the output side 22. Suitable light distribution components 11 include, but are not limited to, star couplers, Rowland circles, multi-mode interference devices, mode expanders and slab waveguides.

An array waveguide grating 24 connects the input light distribution component 14 and the output light distribution component 18. The array waveguide grating 24 includes a plurality of array waveguides 26 that each has a length. Because the array waveguides 26 are often curved, the length is not consistent across the width of the array waveguide 26. As a result, the length of an array waveguide 26 can refer to the length of an array waveguide 26 averaged across the width of the array waveguide 26. Further, the length of an array waveguide 26 can refer to the effective length of the array waveguide 26. Although four array waveguides 26 are illustrated, array waveguide gratings 24 typically include many more than four array waveguides 26 and fewer are possible. Increasing the number of array waveguides 26 can increase the degree of resolution provided by the array waveguide grating 24.

The optical component 10 includes a light signal carrying region (not illustrated) where light signals to be processed by optical component 10 are constrained. The light signal carrying region extends through the input waveguide 12, the input light distribution component 14, the array waveguides 26, the output light distribution component 18 and the output waveguides 16.

During operation of the optical component 10, an input light signal traveling through the light signal carrying region of the input waveguide 12 enters the input light distribution component 14. The light signal enters through the port 23 in the input side 20 of the input light distribution component 14. The input light distribution component 14 distributes the light signal across the output side 22 of the input light distribution component 14. A portion of the light signal enters each array waveguides 26 through a port 23 in the output side 22 of the input light distribution component 14. Accordingly, each array waveguide 26 receives a portion of the input light signal. Each array waveguide 26 carries the received light signal portion to the output light distribution component 18.

The light signal portions entering the output light distribution component 18 from each of the array waveguides 26 combine to form an output light signal. The output light distribution component 18 is constructed to converge the output light signal at a location on the output side 22 of the output light distribution component 18. An output waveguide 16 is positioned at the location on the output side 22 where the light signal is converged receives the output light signal.

Although FIG. 1A illustrates an optical component 10 having a single input waveguide 12, the optical component 10 can have a plurality of input waveguides 12. Further, the optical component 10 can have a single output waveguide 16. For instance, when the optical component 10 is designed without demultiplexing functionality, the optical component 10 can have a single output waveguide 16 that receives all the output light signals.

An index tuner 25 is positioned adjacent to the input light distribution component. The index tuner 25 is configured to tune the index of refraction of a portion of the light signal carrying region. The portion of the light signal carrying region tuned by the index tuner 25 is the functional region of the optical component 10. Accordingly, the index tuner 25 tunes the index of refraction of the functional region such that the index of refraction inside of the functional region is different from the index of refraction outside of the functional region. When the index of refraction inside of the functional region is different from the index of refraction outside of the functional region, the light signal travels through the functional region at a different speed than through the regions outside the functional region. Accordingly, the index tuner 25 can tune the speed at which the light signals travel through the functional region.

The geometry of the functional region is not necessarily constant. For instance, the size of the functional region can change in response to the amount of tuning provided by the index tuner 25. Further, in some instances, the optical component 10 can be operated such that functional region is not present in the light signal carrying region. For instance, the functional region is not present in the light signal carrying region when the index tuner 25 is not engaged and the light signal carrying region does not contain residual energy from a prior engagement of the index tuner 25. The index tuner 25 is not engaged when energy is not being applied to or removed from the index tuner 25.

The shape of the index tuner 25 is selected so as to generate a functional region with a shape that provides the optical component 10 with the desired functionality. For instance, the functional region can have a shape selected to provide the optical component 10 with demultiplexing functionality and/or a dispersion compensation functionality. Demultiplexing functionality causes light signals having different wavelengths to be directed to different regions on the output side 22 of the output light distribution component 18. Different output waveguides 16 can be positioned at each region where a light signal is directed. Accordingly, different output waveguides 16 can carry light signals having different wavelengths. Dispersion compensation functionality causes the output light signal to have a different dispersion profile than the input light signal. The dispersion profile of a light signal is the intensity versus time profile of the light signal.

Although FIG. 1A illustrates the index tuner 25 as being positioned in the input light distribution component 14, the index tuner 25 can be positioned in the output light distribution component 18 as illustrated in FIG. 1B. Additionally, the index tuner 25 need not be positioned adjacent to the output side 22 of the light distribution component as illustrated in FIG. 1A or adjacent to the input side 20 of the light distribution component as shown in FIG. 1B. For instance, the index tuner 25 can be spaced apart from the input side 20 and the output side 22 as shown in FIG. 1C. Further, the optical component 10 can include more than one index tuner 25. For instance, the optical component 10 can include a first index tuner 25 located in the input light distribution component 14 and a second index tuner 25 located in the output light distribution component 18 as shown in FIG. 1D. Additionally, the index tuner 25 can be positioned adjacent to the input waveguide(s) 12 or the output waveguide(s) 16. Further, an index tuner 25 can span different regions of the optical component 10. For instance, an index tuner 25 can be positioned in the input light distribution component 14 and extend into the array waveguide grating 24. Additionally, an index tuner 25 can be positioned in the input light distribution component 14, extend across the array waveguides 26 and be positioned in the output light distribution component 18. Further, an optical component 10 can include a plurality of index tuners 25.

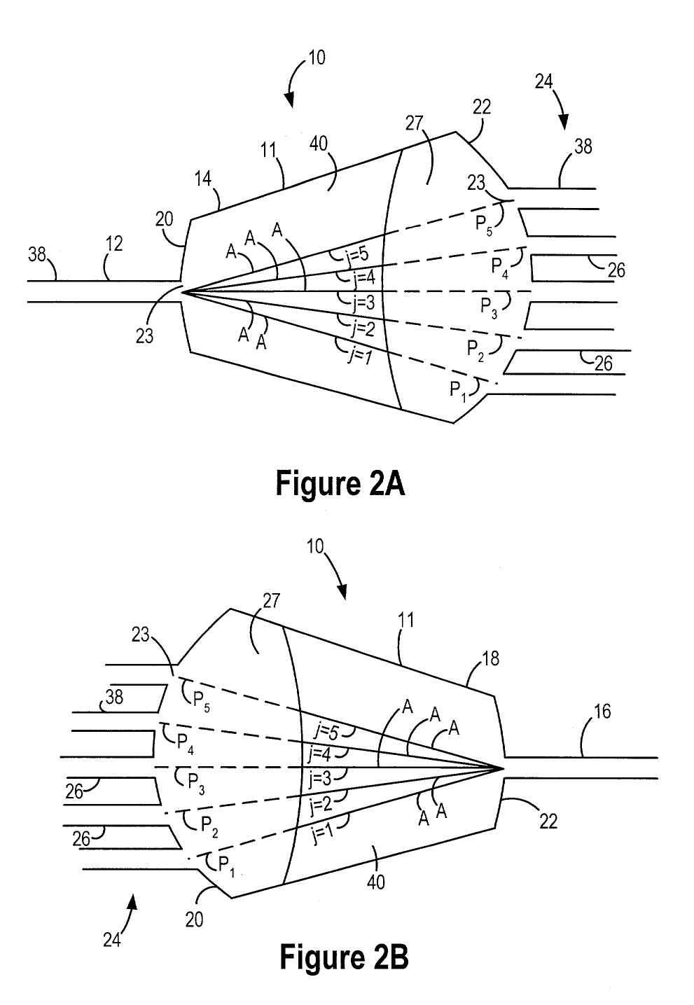

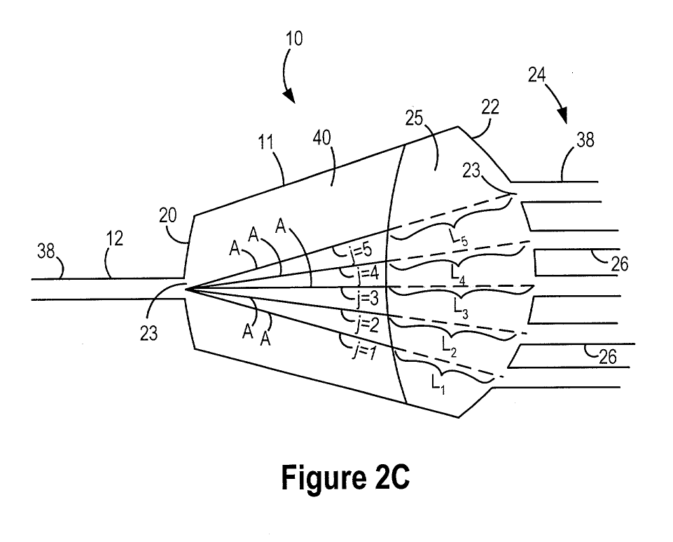

FIG. 2A illustrates operation of an input light distribution component 14 having an index tuner 25. The index tuner 25 is not shown so the location of a functional region 27 generated by the index tuner 25 can be illustrated. During operation of the optical component 10, a light signal is shown entering the input light distribution component 14 from the input waveguide 12. Each line labeled A illustrates a portion of the light signal traveling from the input waveguide 12 to an array waveguide 26. Each portion of the light signal travels through the functional region 27 before entering an array waveguide 26. As a result, each array waveguide 26 is associated with a path through the input light distribution component 14 in that the portion of the light signal that travels through an array waveguide 26 also travels along the associated path through the input light distribution component 14.

FIG. 2B illustrates operation of an output light distribution component 18 having an index tuner 25. The index tuner 25 is not shown so the location of a functional region 27 generated by the index tuner 25 can be illustrated. The output light distribution component 18 is configured to receive portions of a light signal from the array waveguides 26. For instance, portions of a light signal are shown entering the output light distribution component 18 from the array waveguide grating 24. Each of the lines labeled A illustrates a portion of the light signal traveling from an array waveguide 26 to the output waveguide 16. Each portion of the light signal travels from an array waveguide 26 through the functional region 27 before entering the output waveguide 16. Each array waveguide 26 is associated with a path through the output light distribution component 18 in that the portion of the light signal that travels through an array waveguide 26 also travels along the associated path through the output light distribution component 18.

As illustrated in FIG. 2A and FIG. 2B, each path through a light distribution component 11 can be associated with a path index labeled j. The path index can be assigned such that the value of the path index is different for each path and the difference in the value of the path index for adjacent paths is 1. Additionally, the length of path j through the functional region 27 can be denoted by a pathlength labeled, Pⱼ. The length of each path through the functional region 27 is illustrated as a dashed line in FIG. 2A.

As noted above, the index tuner 25 tunes the index of refraction of the light signal carrying region so the index of refraction is different inside and outside of the functional region 27. Accordingly, the speed of a light signal is different inside of the functional region 27 and outside of the functional region 27. The change in the speed of the light signal along a path effectively changes the length of a path through the functional region 27. For instance, the change in the effective length of a path due to the change in index of refraction is (n_{f}−nₛ)*Pⱼ where n_{f} is the effective index of refraction to which the functional region 27 has been tuned and nₛ is the effective index of refraction outside of the functional region 27. Because the portion of the light signal that travels along a path travels through the associated array waveguide 26, the change in the effective length of each path can be viewed as a change to the effective length of an array waveguide 26.

The change in the effective path lengths through the functional region 27 is the source of the functionality provide by the optical component 10. Accordingly, the shape of the index tuner 25 is selected so as to provide the optical component 10 with the desired functionality. For instance, the index tuner 25 can be configured to generate a functional region 27 that provides the optical component 10 with a tunable demultiplexing function and/or with a tunable dispersion compensation function. As a result, the shape of the index tuner 25 is determined by the functionality desired from the optical component 10. Because the index tuner 25 in each of the illustrated optical components 10 can provide the optical component 10 with different functions, the illustrated shape of the illustrated index tuners 25 and functional regions 27 are only for the purpose of illustrating the functional region 27 and the actual shape of the functional region 27 may be different.

FIG. 2C shows an index tuner 25 positioned adjacent to a light distribution component 11. Because each path extends through the light distribution component 11, the index tuner 25 is also located adjacent to each path as indicated by the dashed portion of each path. The length labeled Lⱼ indicates the length of the index tuner 25 adjacent to the path having the path index j. For instance, when an index tuner 25 is positioned over a light distribution component 11, the length of the index tuner 25 positioned over a path having the path index j is Lⱼ. The index tuner 25 need not be positioned over the light distribution component 11 and in some instances can be positioned under the light distribution component 11.

The following discussion discloses selecting values of Lⱼ so as to provide the optical component 10 with a desired functionality. As noted above, the shape of the index tuner 25 is selected so as to provide the optical component 10 with the desired functionality. The shape of the index tuner 25 is limited by the selection of Lⱼ values. For instance, once a suitable selection of Lⱼ values is identified, the shape of the index tuner 25 is selected so as to preserve the identified Lⱼ values.

The index tuner 25 length adjacent to path j, Lⱼ can have a constant component, Lo, and one or more variable components, L(j). The constant component, Lo, can be a length that is the same for each path and can be equal to zero. The variable component, L(j), is a function of the path index, j. The length across the index tuner 25 adjacent to path j, Lⱼ, is Lⱼ=Lo+L(j).

The variable component, L(j), can include a dispersion changing function, L_{DC}(j), that causes the dispersion profile of the light signal to change as the light signal travels through the functional region 27. A suitable dispersion changing function, L_{DC}(j), includes, but is not limited to, an exponential function with a base that is a function of the array waveguide 26 index j. The exponential function causes the profile of the light signal to change in response to traveling across the functional region 27. Equation 1 is an example of a suitable exponential function where f(j) indicates some function of the path index j. Additionally, β and α are constants for each path and are both non zero.

L(j)=L_{DC}(j)=β(f(j))^{α} (1)

A suitable f(j) includes, but is not limited to, j+C as shown in Equation 2. The C is a constant value for each path and can be zero, have a negative value or a positive value.

L(j)=L_{DC}(j)=β(j+C)^{α} (2)

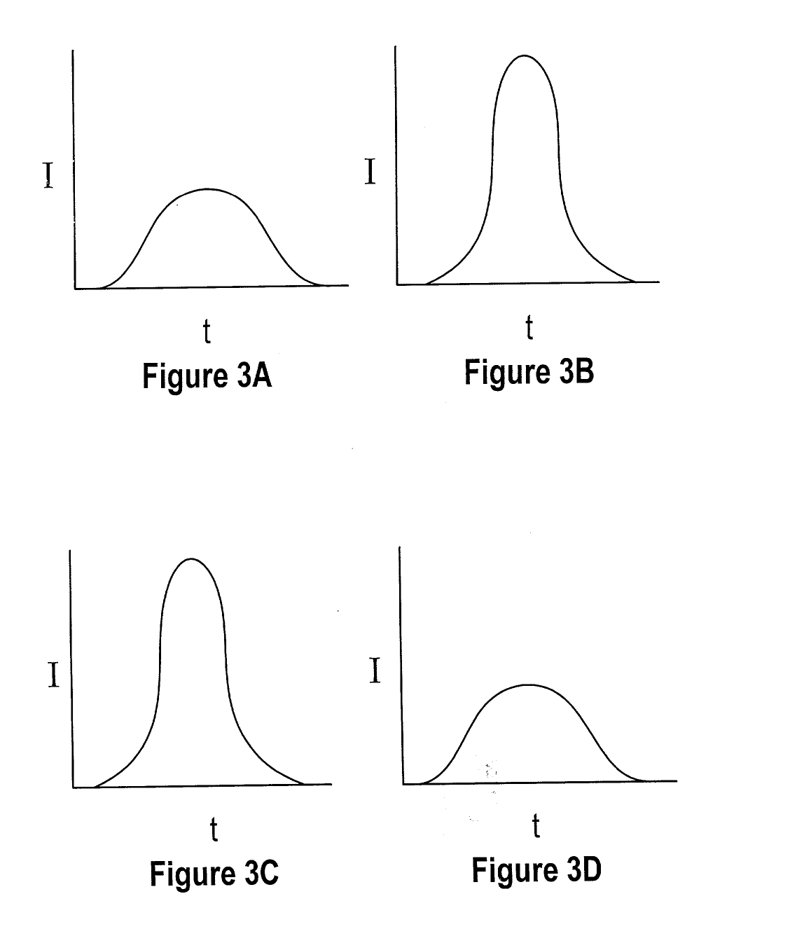

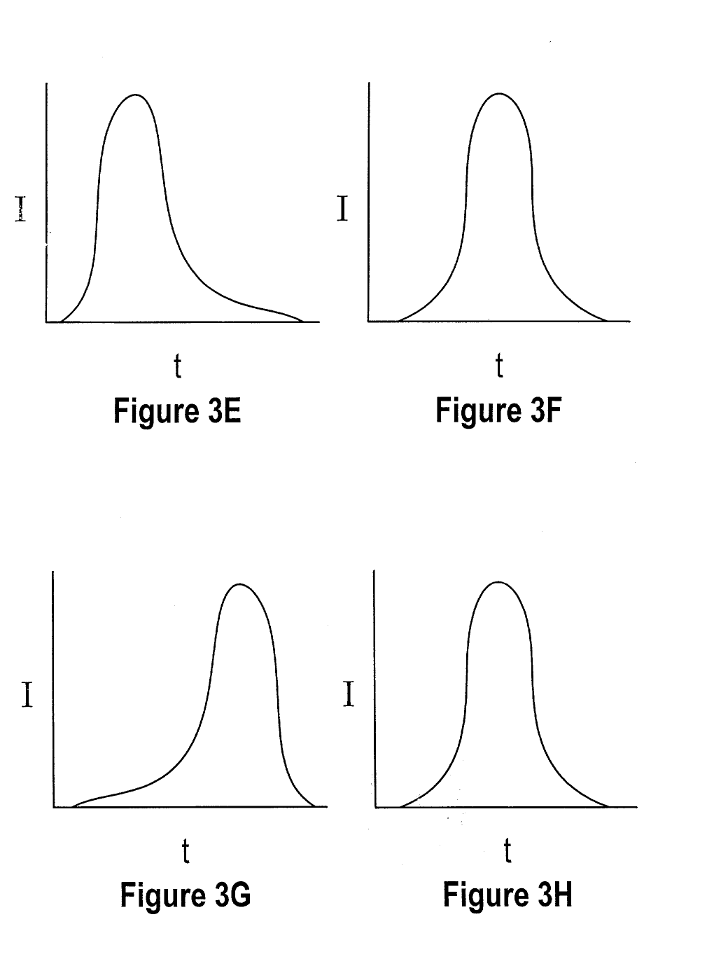

When α is equal to 2, β is negative and the index tuner 25 tuned such that (n_{f}−nₛ)>0 or when α is equal to 2, β is positive and the index tuner 25 tuned such that (n_{f}−nₛ)<0, the dispersion profile of a light signal traveling through the functional region 27 narrows as shown in FIG. 3A and FIG. 3B. FIG. 3A shows the dispersion profile of the light signal before entering the functional region 27. FIG. 3B shows the dispersion profile of the light signal after exiting the functional region 27. The dispersion profile of the light signal narrows in response to the light signal passing through the functional region 27. Accordingly, the functional region 27 causes the light signal to undergo negative dispersion. The negative dispersion change can be generated from the phase 2*π*(n_{f}−nₛ)*L_{DC}/λ.

The index tuner 25 can be employed to tune the amount of negative dispersion compensation. For instance, engaging the index tuners 25 so as to increase the magnitude of |n_{f}−nₛ| increases the amount of negative dispersion compensation while engaging the index tuners 25 so as to decrease the magnitude of |n_{f}−nₛ| decreases the amount of negative dispersion compensation. The shape of the index tuner 25 also affects the degree of negative dispersion provided by the index tuner 25. For instance, the degree of dispersion change caused by the index tuner 25 increases as the magnitude of β increases. Accordingly, when larger changes in dispersion profile are desired the index tuner 25 can be designed with an increased β magnitude.

When α is equal to 2, β is positive and the index tuner 25 tuned such that (n_{f}−nₛ)>0 or when α is equal to 2, β is negative and the index tuner 25 tuned such that (n_{f}−nₛ)<0, the dispersion profile broadens as shown in FIG. 3C and FIG. 3D. FIG. 3C shows the dispersion profile of the light signal before entering the functional region 27 and FIG. 3D shows the dispersion profile of the light signal after the light signal exits the functional region 27. The dispersion profile of the light signal broadens in responses to passing through the functional region 27. Accordingly, the functional region 27 causes the input light signal to undergo positive dispersion. This positive dispersion can be generated from the phase |2*π*(n_{f}−nₛ)*L_{DC}/λ.

The index tuner 25 can be employed to tune the amount of positive dispersion compensation. For instance, engaging the index tuners 25 so as to increase the magnitude of |n_{f}−nₛ| increases the amount of positive dispersion compensation while engaging the index tuners 25 so as to decrease the magnitude of |n_{f}−nₛ| decreases the amount of positive dispersion compensation. The shape of the index tuner 25 also affects the degree of positive dispersion provided by the index tuner 25. For instance, the degree of dispersion change caused by the index tuner 25 increases as the magnitude of β increases. Accordingly, when larger changes in dispersion profile are desired the index tuner 25 can be designed with an increased β magnitude.

Other values of α and β can be used to change other features of the dispersion profile. For instance, when α is greater than 2, β is positive and the index tuner 25 tuned such that (n_{f}−nₛ)>0 or when α is greater than 2, β is negative and the index tuner 25 tuned such that (n_{f}−nₛ)<0, positive dispersion slope results as shown in FIG. 3E and FIG. 3F. FIG. 3E shows the dispersion profile of the light signal before entering the functional region 27 and FIG. 3F shows the dispersion profile of the light signal after the light signal exits the functional region 27. The functional region 27 generated by the index tuner 25 causes the output dispersion profile to shift toward longer times as compared to the input light signal. This shift is caused by the dispersion slope.

The index tuner 25 can be employed to tune the amount of positive dispersion slope compensation. For instance, engaging the index tuners 25 so as to increase the magnitude of |n_{f}−nₛ| increases the amount of positive slope dispersion compensation while engaging the index tuners 25 so as to decrease the magnitude of |n_{f}−nₛ| decreases the amount of positive slope dispersion compensation. The shape of the index tuner 25 also affects the degree of positive dispersion provided by the index tuner 25. For instance, the degree of dispersion slope change caused by the index tuner 25 increases as the magnitude of β increases. Accordingly, when larger changes in dispersion slope are desired the index tuner 25 can be designed with an increased β magnitude.

When α is greater than 2, β is negative and the index tuner 25 tuned such that (n_{f}−nₛ)>0 or when α is greater than 2, β is positive and the index tuner 25 tuned such that (n_{f}−nₛ)<0, negative dispersion slope results as shown in FIG. 3G and FIG. 3H. FIG. 3G shows the dispersion profile of the light signal before entering the functional region 27 and FIG. 3H shows the dispersion profile of the light signal after the light signal exits the functional region 27. The functional region 27 causes the output dispersion profile to shift more toward shorter times than the input light signal.

The index tuner 25 can be employed to tune the amount of negative dispersion slope compensation. For instance, engaging the index tuners 25 so as to increase the magnitude of |n_{f}−nₛ| increases the amount of negative slope dispersion compensation while engaging the index tuners 25 so as to decrease the magnitude of |n_{f}−nₛ| decreases the amount of negative slope dispersion compensation. The shape of the index tuner 25 also affects the degree of negative dispersion provided by the index tuner 25. For instance, the degree of dispersion slope change caused by the index tuner 25 increases as the magnitude of β increases. Accordingly, when larger changes in dispersion slope are desired the index tuner 25 can be designed with an increased β magnitude.

When α is increased to three or higher the optical component 10 can compensate for higher order dispersion. Hence, the optical component 10 has the ability to compensate an arbitrary dispersion response using higher order dispersion changing functions.

A suitable C for use in equation 2 includes, but is not limited to, a function of N. Suitable functions of N include, but are not limited to, −N/2 and −(N+1)/2 as shown in Equation 3. When C is −(N+1)/2, the exponential function is centered relative to the array waveguides 26. More specifically, the length across the index tuner 25, Lⱼ, is shortest adjacent to the (N+1)/2 th path when the number of array waveguides 26 is odd and the N/2−0.5 th and N/2+0.5 th path when the number of array waveguides 26 is even. The exponential function need not be centered relative to the array waveguides 26 in order for the optical component 10 to operate. For instance, C can be equal to zero.

L(j)=L_{DC}(j)=β(j−(N+1)/2)^{α} (3)

The effects of the variable component, L(j), are additive. As a result, the length across the index tuner 25 adjacent to path j, Lⱼ, can include more than one variable component, L(j). For instance, the index tuner 25 can be designed so as to produce negative dispersion and positive dispersion slope. Alternatively, two index tuners 25 can be employed. The two index tuners can be connected in series, parallel or independently controlled. One of the index tuners 25 can be designed so as to produce negative dispersion and another to produce positive dispersion slope. As a result, the dispersion profile on the output waveguide 16 would be narrower and/or more shifted toward the longer times than the dispersion profile on the input waveguide 12. Other combinations include, but are not limited to, negative dispersion and negative dispersion slope; positive dispersion and positive dispersion slope or positive dispersion and negative dispersion slope.

Equation 4 shows an equation for the length across the index tuner 25 adjacent to path j, Lⱼ, having more than one variable component, L(j).

Lⱼ=Lo+L_{DC}(j)+L′_{DC}(j)=Lo+ [symbol] (j−N/2)^{α}+ [symbol] ′(j−N/2)^{α′} (4)

The value of α, α′, [symbol] . and α′ are selected so as to achieve the desired combination of variable component effects. For instance, when it is desired to produce an optical component 10 having negative dispersion and positive dispersion slope, the value of α is 2, β is negative and [symbol] is greater than 2 and β′ is positive. Tuning the index tuners 25 such that (n_{f}−nₛ)>0 provides the negative dispersion and the positive dispersion slope. The values of β and β′ are often less than one.

The index tuner 25 can be designed to with a shape that provides the optical component 10 with a demultiplexing function. The demultiplexing function causes light signals having different wavelengths to be directed to different regions of the output side 22 of the output light distribution component 18. A demultiplexing function results when the index tuner 25 is designed such that the length across the index tuner 25 adjacent to path j, Lⱼ, is different for each path, j, and such that the difference in the length, Lⱼ, for adjacent paths is a constant. For instance, the variable component, L(j), can include a demultiplexing function, L_{D}(j), such as L_{D}(j)=(j−1)ΔL, (j) Δ [symbol] (N−j)ΔL or (N−j+1)ΔL where ΔL is a non-zero constant and Lₒ can be equal to 0, ΔL or another constant.

In order to simplify describing operation of an optical component 10 having a demultiplexing function, L_{D}(j), it is presumed that the variable component, L(j) is equal to the demultiplexing function, L_{D}(j) and that the length of each array waveguide 26 is the same. The shape of the functional region 27 generated by the index tuner 25 approximates the shape of the index tuner 25. As a result, each path through the functional region 27 generated by the index tuner 25 has a different length and the difference in the length of adjacent paths through the functional region 27 is substantially constant. The portion of a light signal traveling a longer path through the functional region 27 will take longer to cross the functional region 27 than the portion of a light signal traveling through the functional region 27 along a shorter path. As a result, the changed index of refraction in the functional region 27 affects the speed of the portion of the light signal traveling through on the longer path more than the portion traveling on the shorter path. Hence, the functional region 27 causes these portions of the light signal to enter the array waveguides 26 in different phases. Because each array waveguide is presumed to have the same length, these portions of the light signal also enter the output light distribution component 18 in different phases.

The light signal portions entering the output light distribution component 18 from each of the array waveguides 26 combines to form the output light signal. Because the index tuner 25 generates a functional region 27 that causes a phase differential between the portions of the light signal entering the output light distribution component 18, the output light signal is diffracted at an angle. The output light distribution component 18 is constructed to converge the output light signal at a location on the output side 22 of the output light distribution component 18. The location where the output light signal is incident on the output side 22 of the output light distribution component 18 is a function of the diffraction angle.

Because the difference in the length of adjacent paths through the functional region 27 is a different percent of the wavelength for each channel, the amount of the phase differential is different for different channels. As a result, different channels are diffracted at different angles and are accordingly converged at different locations on the output side 22. Hence, when light signals having different wavelengths enter the output light distribution component 18, each light signal having different wavelengths is converged at a different location on the output side 22. In some instances, one or more output waveguides 16 are positioned at each location on the output side 22 where a channel is converged. As a result, one or more of the output waveguides 16 can carry light signals having different wavelengths or different channels.

When the index tuner 25 is configured to provide a demultiplexing function, engaging the index tuners 25 so as to change the magnitude of |n_{f}−nₛ| changes the value of the difference in the length of adjacent paths through the functional region 27. As a result, the diffraction angle changes and the location where each channel is incident on the output side 22 shifts. This feature can be used to provide a tunable filter. For instance, the index tuner 25 can be engaged so that a particular channel is incident at a location on the output side 22 where the port 23 of a particular output waveguide 16 is located. The particular output waveguide 16 would carry the particular channel. As a result, the optical component 10 can be tuned such that particular output waveguide(s) carry particular channels.

The index tuner 25 can be configured to generate a functional region 27 that provides only a demultiplexing function or only a dispersion changing function. Additionally, the index tuner 25 can be configured to generate a functional region 27 that provides a demultiplexing function and a dispersion changing function. For instance, the demultiplexing function, L_{D}(j), is additive with the one or more dispersion changing functions, L_{DC}(j). As a result, the variable component, L(j), can include both a dispersion changing function, L_{DC}(j), and a demultiplexing function, L_{D}(j). When the functional region 27 is configured to have both a demultiplexing function, L_{D}(j), and a dispersion changing function, L_{DC}(j), the output light signal associated with each channel exhibits the effects of the dispersion changing function, L_{DC}(j). For instance, when the dispersion changing function, L_{DC}(j), provides a narrowing of the dispersion profile, each of the output light signals on an output waveguide 16 has a narrower dispersion profile than the associated input light signal had on the input waveguide 12. Accordingly, the optical component 10 can concurrently provide dispersion changing functions, L_{DC}(j), and a demultiplexing function, L_{D}(j).

The dispersion changing function, L_{DC}(j), does have some affect on the bandwidth of the demultiplexing function. The amount of the bandwidth change is reduced with reduced magnitude of β and α. Further, the amount of bandwidth change is generally low when β and α are less than one. However, the amount of change to the bandwidth can often be designed out or is often negligible.

Equation 5 shows an equation for the lengths across an index tuner 25 configured to generate a functional region 27 having both a demultiplexing function, L_{D}(j), and a dispersion changing function, L(j). The value of ΔL, α and β are selected so as to achieve the desired combination of demultiplexing and dispersion. For instance, when it is desired to produce demultiplexing and negative dispersion, ΔL is not equal to zero, the value of α is 2 and 0 is negative.

Lⱼ=Lo+L_{D}(j)+L_{DC}(j)=Lo+jΔL+β(j+C)^{α} (5)

As noted above, the dispersion changing functions, L_{DC}(j), are additive. As a result, Equation 5 can include two or more dispersion changing functions, L_{DC}(j), as shown in Equation 6.

Lⱼ=Lo+L_{D}(j)+L_{DC}(j)+L′_{DC}(j) (6)

In some instances, the index tuner 25 is configured to produce a functional region 27 with a shape that matches the shape of the light signal wavefront. The wavefront is substantially semi-circular. As a result, the index tuner 25 is configured to produce a functional region 27 such that the side through which the light signals enter is substantially semi-circular. In some instances, the side of the index tuner 25 closest to the input waveguide 12 is substantially semi-circular in order to produce a functional region 27 having a substantially semi-circular side. When the side of the index tuner 25 closest to the input waveguide 12 is substantially semi-circular, the remainder of the index tuner 25 is shaped so as to preserve the length across the index tuner 25 adjacent to path j, Lⱼ, relationships discussed above. Matching the side of the functional region 27 to the wavefront causes the light signal to enter the functional region 27 at an angle that is substantially perpendicular. The perpendicular angle reduces bending or reflection of the light signal in response to the change in the index of refraction that occurs at the functional region 27.

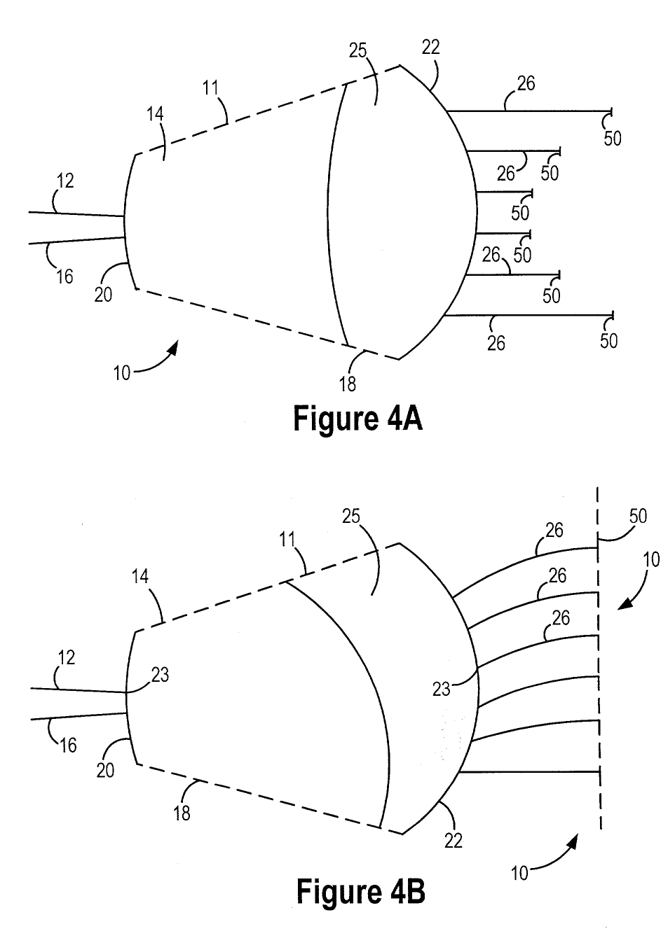

Each of the optical components 10 shown above can be constructed with a single light distribution component 11 by positioning reflectors 50 along the array waveguides 26 as shown in FIG. 4A. The optical component 10 includes an input waveguide 12 and an output waveguide 16 that are each connected to the output side 22 of the light distribution component 11. The array waveguides 26 include a reflector 50 configured to reflect light signal portions back toward the light distribution component 11.

The optical component 10 of FIG. 4A has an index tuner 25 with lengths selected as described above. However, the light signals travel through the functional region 27 twice. As a result, the length across the index tuner 25 adjacent to path j, Lⱼ, is effectively twice the physical length. Accordingly, the length across the index tuner 25 adjacent to path j, Lⱼ, can be half the length of the functional region 27 shown in FIG. 1A while still providing the same degree of functionality.

FIG. 4B illustrates another embodiment of an optical component 10 having a single light distribution component 11 and curved array waveguides 26. The optical component 10 is included on an optical component 10. The edge of the optical component 10 is shown as a dashed line. The edge of the optical component 10 can include one or more reflective coatings positioned so as to serve as reflector(s) 50 that reflect light signals from the array waveguides 26 back into the array waveguides 26. Alternatively, the edge of the optical component 10 can be smooth enough to act as a mirror that reflects light signals from the array waveguide 26 back into the array waveguide 26. An optical component 10 having an optical component 10 according to FIG. 4B can be fabricated by making an optical component 10 having an optical component 10 according to FIG. 1A, FIG. 1B or FIG. 1C and cleaving the optical component 10 down the center of the array waveguides 26. When the optical component 10 was symmetrical about the cleavage line, two optical components 10 can result. Because, the light signal must travel through each array waveguide 26 twice, each resulting optical components 10 will provide about the same degree of dispersion compensation as would have been achieved before the optical component 10 was cleaved.

Although the optical component 10 of FIG. 4A and FIG. 4B are shown with a single input waveguide 12 and a single output waveguide 16, the optical component 10 can include a plurality of input waveguides 12 and/or a plurality of output waveguides 16.

As noted above, the optical components 10 illustrated above can include more than one index tuner 25. When the optical component 10 includes more than one index tuner 25, the functionality provided by the index tuners 25 can enhance one another. For instance, a first index tuner 25 and a second index tuner 25 can both be configured to provide a demultiplexing function. The functionality provided by the index tuners 25 can also oppose one another. For instance, a first index tuner 25 can be configured to provide positive dispersion and a second index tuner 25 can be configured to provide negative dispersion. The range of dispersion compensation provide by the first index tuner 25 and the second index tuner 25 is greater than the range that can be provided without the use of index tuners 25 with opposing functionality. Further, the functionality provided by a first index tuner 25 can be different from the functionality provided by a second index tuner 25. For instance, a first index tuner 25 positioned in the input light distribution component 14 can be configured to provide positive dispersion and a second index tuner 25 positioned in the output light distribution component 18 can be configured to provide positive slope dispersion.

The array waveguide grating 24 can be configured to provide the optical component 10 with one or more dispersion compensation functions and/or a demultiplexing function as described in U.S. patent application Ser. No. 09/866,491; filed on May 25, 2001; entitled “Dispersion Compensator” and incorporated herein in its entirety and in U.S. patent application Ser. No. 09/872,473; filed on Jun. 1, 2001; entitled “Tunable Dispersion Compensator” and incorporated herein in its entirety. The functionality provided by the array waveguide grating 24 can enhance the functionality provided by the one or more index tuners 25. For instance, the index tuner 25 and the array waveguide grating 24 can both be configured to provide a demultiplexing function. Further, the functionality provided by the array waveguide grating 24 can be different from the functionality provided by the one or more index tuners 25. For instance, the index tuner 25 can be configured to provide positive dispersion and the array waveguide grating 24 can be configured to provide positive slope dispersion.

The one or more light distribution components 11 can also include one or more secondary functional regions. The index of refraction of the light signal carrying region inside of a secondary functional region is different than the index of refraction of the light signal carrying region outside of the secondary functional region when the index tuners 25 are disengaged. The one or more secondary functional regions can be configured to provide dispersion compensation functionality and/or demultiplexing functionality. Suitable secondary functional regions are taught in U.S. patent application Ser. No. 09/924,403; filed on Aug. 6, 2001; entitled “Optical Component Having a Light Distribution Component with a Functional Region.” The functionality provided by the one or more secondary functional regions can enhance the functionality provided by the one or more index tuners 25. For instance, the index tuner 25 and the one or more secondary functional regions can both be configured to provide a demultiplexing function. Further, the functionality provided by the one or more secondary functional regions can be different from the functionality provided by the one or more index tuners 25. For instance, the index tuner 25 can be configured to provide positive dispersion and the one or more secondary functional regions can be configured to provide positive slope dispersion. Each of the one or more secondary functional regions can be positioned apart from the index tuner 25 or can be positioned adjacent to the index tuner 25. A secondary functional region positioned adjacent to an index tuner 25 can enhance the tuning range provided by the optical component 10.

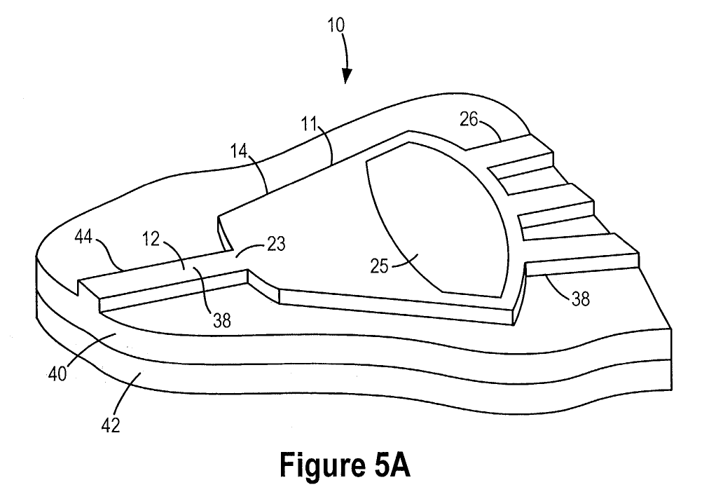

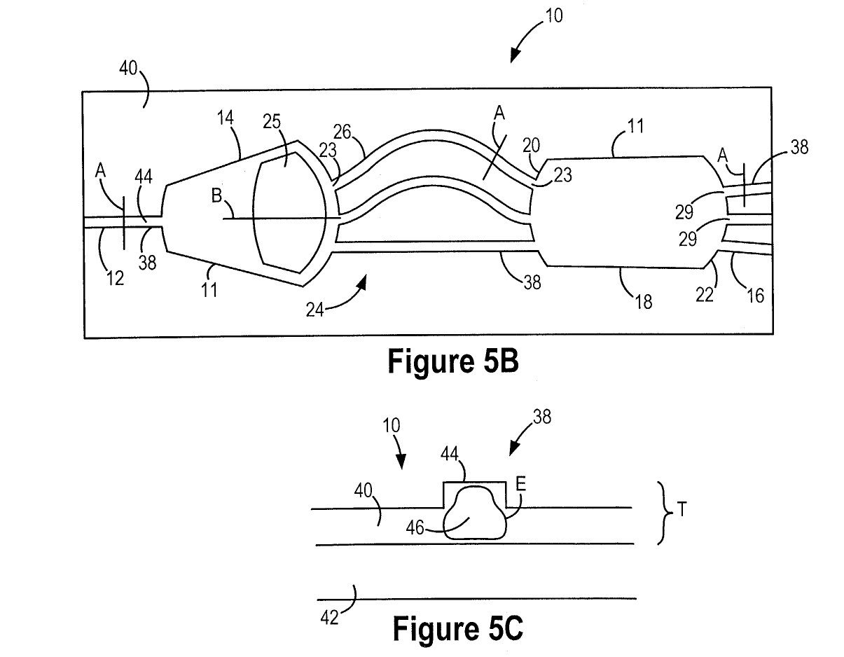

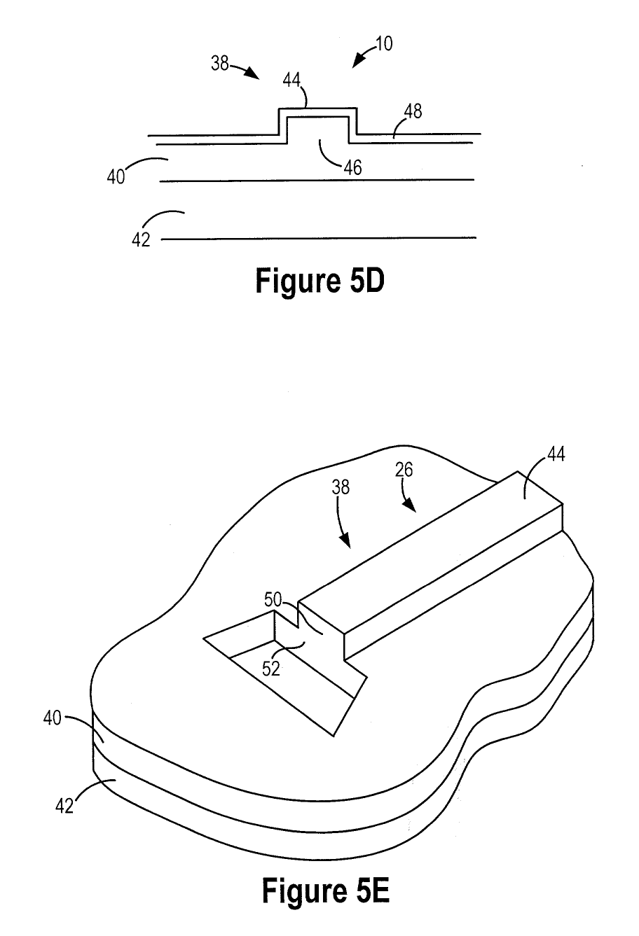

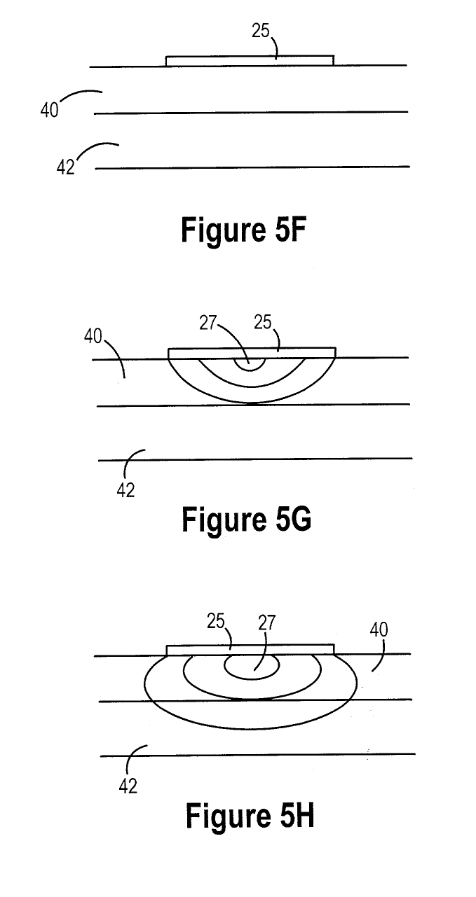

FIG. 5A through FIG. 5G illustrate suitable construction of an optical component 10 having an index tuner 25. FIG. 5A is a perspective view of a portion of an optical component 10. The illustrated portion has an input light distribution component 14, an input waveguide 12 and a plurality of array waveguides 26. FIG. 5B is a top view of an optical component 10 constructed according to FIG. 5A. FIG. 5C is a cross section of the optical component 10 in FIG. 5B taken at any of the lines labeled A. Accordingly, the waveguide 38 illustrated in FIG. 5C could be the cross section of an input waveguide 12, an array waveguide 26 or an output waveguide 16.

For purposes of illustration, the optical component 10 is illustrated as having three array waveguides 26 and an output waveguide 16. However, array waveguide 26 gratings 24 for use with an optical component 10 can have many more than three array waveguides 26. For instance, array waveguide gratings 24 can have tens to hundreds or more array waveguides 26.

The optical component 10 includes a light transmitting medium 40 on a base 42. The light transmitting medium 40 includes a ridge 44 that defines a portion of the light signal carrying region 46 of a waveguide 38. Suitable light transmitting media include, but are not limited to, silicon, polymers, silica, GaAs, InP, SiN, SiC and LiNbO₃. As will be described in more detail below, the base 42 reflects light signals from the light signal carrying region 46 back into the light signal carrying region 46. As a result, the base 42 also defines a portion of the light signal carrying region 46. The line labeled E illustrates the mode profile of a light signal carried in the light signal carrying region 46 of FIG. 5C. The light signal carrying region 46 extends longitudinally through the input waveguide 12, the input light distribution component 14, each the array waveguides 26, the output light distribution component 18 and each of the output waveguides 16.

The array waveguides 26 illustrated in FIG. 5A are shown as having a curved shape. A suitable curved waveguide is taught in U.S. patent application Ser. No. 09/756,498, filed on Jan. 8, 2001, entitled “An efficient Curved Waveguide” and incorporated herein in its entirety. Other optical component 10 constructions can also be employed. For instance, the principles of the invention can be applied to array waveguide gratings 24 having straight array waveguides 26. Array waveguide gratings 24 having straight array waveguides 26 are taught in U.S. patent application Ser. No. 09/724,175, filed on Nov. 28, 2000, entitled “A Compact Integrated Optics Based Array Waveguide Demultiplexer” and incorporated herein in its entirety.

A cladding layer 48 can be optionally being positioned over the light transmitting medium 40 as shown in FIG. 5D. The cladding layer 48 can have an index of refraction less than the index of refraction of the light transmitting medium 40 so light signals from the light transmitting medium 40 are reflected back into the light transmitting medium 40. Because the cladding layer 48 is optional, the cladding layer 48 is shown in some of the following illustrations and not shown in others.

FIG. 5E illustrates a suitable construction of a reflector 50 for use within optical component 10 such as the optical component 10 of FIG. 4A. The reflector 50 includes a reflecting surface 52 positioned at an end of an array waveguide 26. The reflecting surface 52 is configured to reflect light signals from an array waveguide 26 back into the array waveguide 26. The reflecting surface 52 extends below the base of the ridge 44. For instance, the reflecting surface 52 can extend through the light transmitting medium 40 to the base 42 and in some instances can extend into the base 42. The reflecting surface 52 extends to the base 42 because the light signal carrying region 46 is positioned in the ridge 44 as well as below the ridge 44 as shown in FIG. 5C. As result, extending the reflecting surface 52 below the base of the ridge 44 increases the portion of the light signal that is reflected.

A variety of index tuners 25 can be used in conjunction with the optical component 10 of FIG. 5A. For instance, one or more index tuners 25 can be a temperature control device such as a resistive heater. Increasing the temperature of the light transmitting medium 40 causes the index of refraction of the light transmitting medium 40 to increase and accordingly increases the effective length across the functional region 27. Alternatively, one or more index tuners 25 can include an electrical contact 54 configured to cause flow of an electrical current through the functional region 27. The electrical current causes the index of refraction of the light transmitting medium 40 to decrease and accordingly decreases the effective length across the functional region 27. Increasing the level of current increases the reduction in effective length. Further, each index tuner 25 can include an electrical contact 54 configured to cause formation of an electrical field through the array waveguide 26. The electrical field causes the index of refraction of the light transmitting medium 40 to increase and accordingly increases the effective length across the functional region 27. Increasing the electrical field increases the effective length across the functional region 27. Other effective length tuners are possible. For instance, the index of refraction of many light transmitting media often changes in response to application of a force. As a result, the effective length tuner can apply a force to the light transmitting medium. A suitable device for application of a force to the light transmitting medium is a piezoelectric crystal. The index of refraction of some light transmitting media also changes in response to application of magnet to the light transmitting medium. As a result, the effective length tuner can apply a tunable magnetic field to the light transmitting medium. A suitable device for application of a magnetic field to the light transmitting medium is a magnetic-optic crystal.

FIG. 5F is a cross sections of the optical component 10 taken along the line labeled B in FIG. 5B. The illustrated index tuner 25 is a metal layer that can be used as a resistive heater configured to evenly apply heat to the light transmitting medium. The shape of the metal layer can match the desired shapes of the index tuner. In some instances, an insulator, such as oxide, can be positioned between the light transmitting medium and the metal layer. The insulator can help restrain the thermal energy to the area under the metal layer so the metal layer serves as a localizer heater.

Increasing the temperature of the light transmitting medium 40 causes the index of refraction of the light transmitting medium 40 to increase while decreasing the temperature of the light transmitting medium 40 causes the index of refraction of the light transmitting medium 40 to decrease. Suitable metal layers for use as a resistive heater include, but are not limited to, Cr, Au and NiCr.

When the index tuner 25 is a temperature control device, the size of the functional region 27 generated by the temperature control device need not be constant over the entire range that the index tuner 25 is tuned during operation. FIG. 5G illustrates a plurality of isothermal lines generated by a resistive heater. FIG. 5H illustrates a plurality of isothermal lines when the index tuner 25 of FIG. 5G is operated so increase the magnitude of change to the index of refraction. The functional region 27 illustrated in FIG. 5G falls within the perimeter of the index tuner 25 while the functional region 27 illustrated in FIG. 5H extends beyond the perimeter of the index tuner 25. Accordingly, the size of the functional region 27 can change in response to the desired degree of change to the index of refraction.

While the size of the functional region 27 can vary, the shape of the functional region 27 approximates the shape of the index tuner 25 and accordingly can remain substantially constant over the desired tuning range of the index tuner 25. However, because the size of the tuning range can vary, each of the equations presented above are approximations. The optimal shape of an index tuner 25 can be experimentally determined using the above equations as a starting point and can vary depending on the choice of index tuner 25.

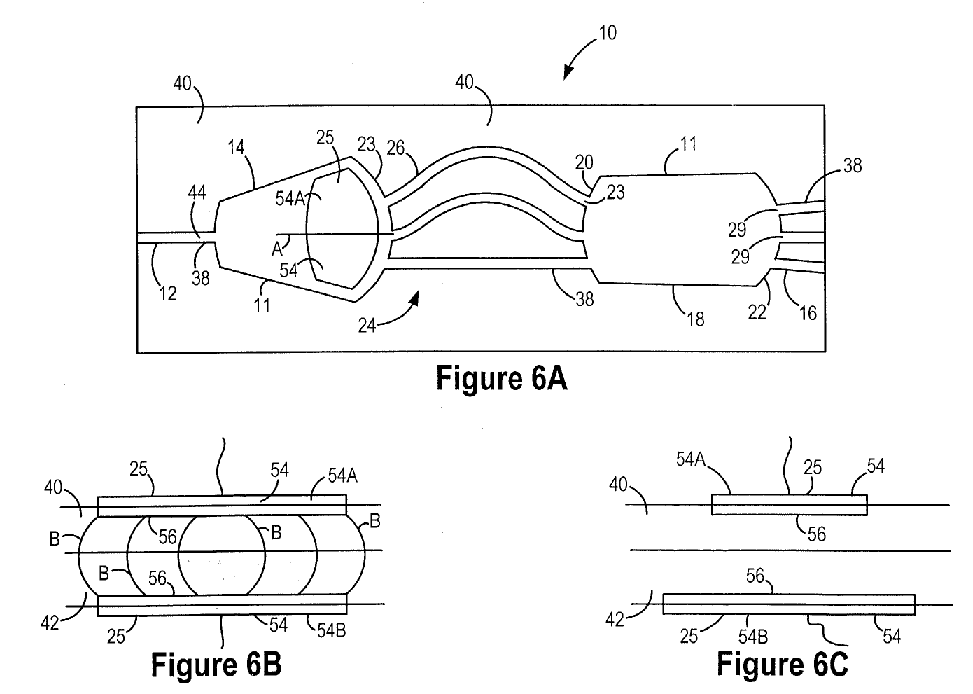

As noted above, the index tuner 25 can include a plurality of electrical contacts 54. FIG. 6A is a top view of an optical component 10 having an index tuner 25 that includes a first electrical contact 54A and a second electrical contact 54B. FIG. 6B is a cross section of the component shown in FIG. 6A taken at the line labeled A. The effective length tuners include a first electrical contact 54A positioned over the ridge and a second electrical contact 54B positioned under the ridge on the opposite side of the component. A doped region 56 is formed adjacent to each of the electrical contacts 54. The doped regions 56 can be N-type material or P-type material. When one doped region 56 is an N-type material, the other doped region 56 is a P-type material. For instance, the doped region 56 adjacent to the first electrical contact 54A can be a P type material while the material adjacent to the second electrical contact 54B can be an N type material. In some instances, the regions of N type material and/or P type material are formed to a concentration of 10⁽¹⁷⁻²¹⁾/cm³ at a thickness of less than 6 μm, 4 μm, 2 μm, 1 μm or 0.5 μm. The doped region 56 can be formed by implantation or impurity diffusion techniques.

During operation of the effective length tuner, a potential is applied between the electrical contacts 54. The potential causes the index of refraction of the light transmitting medium positioned between the electrical contacts 54 to change as shown by the lines labeled B. As illustrated by the lines labeled B, the shape of the shape of the functional region 27 approximates the shape of the first electrical contact 54A.

When the potential on the electrical contact 54 adjacent to the P-type material is less than the potential on the electrical contact 54 adjacent to the N-type material, a current flows through the light transmitting medium and the index of refraction decreases. The reduced index of refraction decreases the effective length across the functional region 27. When the potential on the index changing element adjacent to the P-type material is greater than the potential on the index changing element adjacent to the N-type material, an electrical field is formed between the index changing elements and the index of refraction increases. The increased index of refraction increases the effective length across the functional region 27. As a result, the electrical contacts 54 can be employed to increase the index of refraction or to decrease the index of refraction by changing the polarity on the first electrical contact 54A and the second electrical contact 54B. The ability to increase or decrease the index of refraction increases the tuning range of the optical component 10. For instance, the total range of dispersion compensation or demultiplexing based tuning is increased.

Increasing the potential applied between the electrical contacts 54 increases the magnitude of the change in index of refraction. For instance, when the index tuner 25 is being employed to increase the length across the functional region 27, increasing the potential applied between the electrical contacts 54 further increases the length across the functional region 27.

The tuning range of effective length tuners that include electrical contacts 54 can be limited by free carrier absorption that develops when higher potentials are applied between the electrical contacts 54. Free carrier absorption can cause optical loss. Choosing a light transmitting medium with an index of refraction that is highly responsive to current or electrical fields can improve the tuning range.

The second electrical contact 54B can be about the same size as the first electrical contact 54A as shown in FIG. 6B. Alternatively, the second electrical contact 54B can be smaller than the first electrical contact 54A or larger than the first electrical contact 54A as shown in FIG. 6C. The different size of the second electrical contact 54B can improve the shape and uniformity of the functional region 27.

The second electrical contact 54B need not be positioned under the ridge as shown in FIG. 6A through FIG. 6C. For instance, one or both of the electrical contacts 54 can be positioned adjacent to the ridge.

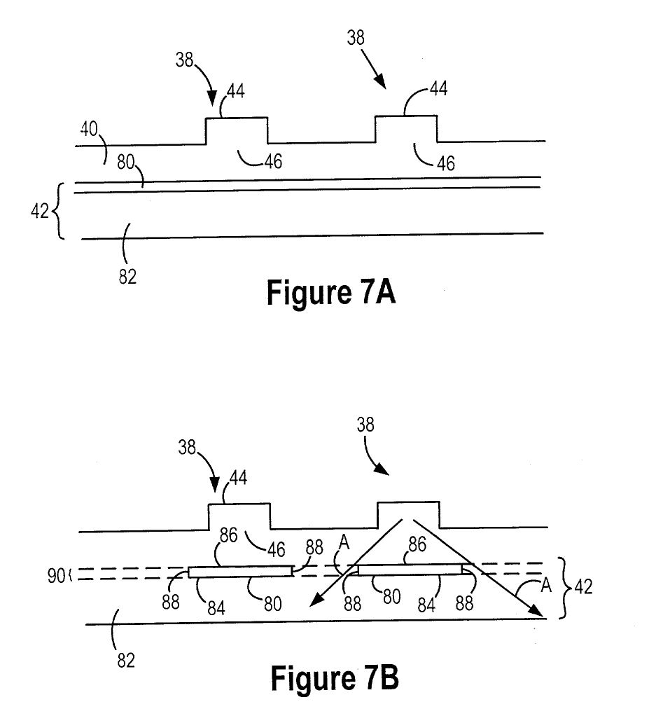

The base 42 can have a variety of constructions. FIG. 7A illustrates a optical component 10 having a base 42 with a light barrier 80 positioned over a substrate 82. The light barrier 80 serves to reflect the light signals from the light signal carrying region 46 back into the light signal carrying region 46. Suitable light barriers 80 include material having reflective properties such as metals. Alternatively, the light barrier 80 can be a material with a different index of refraction than the light transmitting medium 40. The change in the index of refraction can cause the reflection of light from the light signal carrying region 46 back into the light signal carrying region 46. A suitable light barrier 80 would be silica when the light carrying medium and the substrate 82 are silicon. Another suitable light barrier 80 would be air or another gas when the light carrying medium is silica and the substrate 82 is silicon. A suitable substrate 82 includes, but is not limited to, a silicon substrate 82.

The light barrier 80 need not extend over the entire substrate 82 as shown in FIG. 7B. For instance, the light barrier 80 can be an air filled pocket formed in the substrate 82. The pocket 84 can extend alongside the light signal carrying region 46 so as to define a portion of the light signal carrying region 46.

In some instances, the light signal carrying region 46 is adjacent to a surface 86 of the light barrier 80 and the light transmitting medium 40 is positioned adjacent to at least one side 88 of the light barrier 80. As a result, light signals that exit the light signal carrying region 46 can be drained from the waveguide 38 as shown by the arrow labeled A. These light signals are less likely to enter adjacent array waveguide 26. Accordingly, these light signals are not a significant source of cross talk.

The drain effect can also be achieved by placing a second light transmitting medium 90 adjacent to the sides 88 of the light barrier 80 as indicated by the region below the level of the top dashed line or by the region located between the dashed lines. The drain effect is best achieved when the second light transmitting medium 90 has an index of refraction that is greater than or substantially equal to the index of refraction of the light transmitting medium 40 positioned over the base 42. In some instances, the bottom of the substrate 82 can include an anti reflective coating that allows the light signals that are drained from a waveguide 38 to exit the optical component 10.

The input waveguide 12, the array waveguides 26 and/or the output waveguide 16 can be formed over a light barrier 80 having sides 88 adjacent to a second light transmitting medium 90.

The drain effect can play an important role in improving the performance of the optical component 10 because the array waveguide grating 24 includes a large number of waveguides 38 formed in close proximity to one another. The proximity of the waveguides 38 tends to increase the portion of light signals that act as a source of cross talk by exiting one waveguide 38 and entering another. The drain effect can reduce this source of cross talk.

Other base 42 and optical component 10 constructions suitable for use with an optical component 10 according to the present invention are discussed in U.S. patent application Ser. No. 09/686,733, filed on Oct. 10, 2000, entitled “Waveguide Having a Light Drain” and U.S. patent application Ser. No. ______ (not yet assigned), filed on Feb. 15, 2001, entitled “Component Having Reduced Cross Talk” each of which is incorporated herein in its entirety.

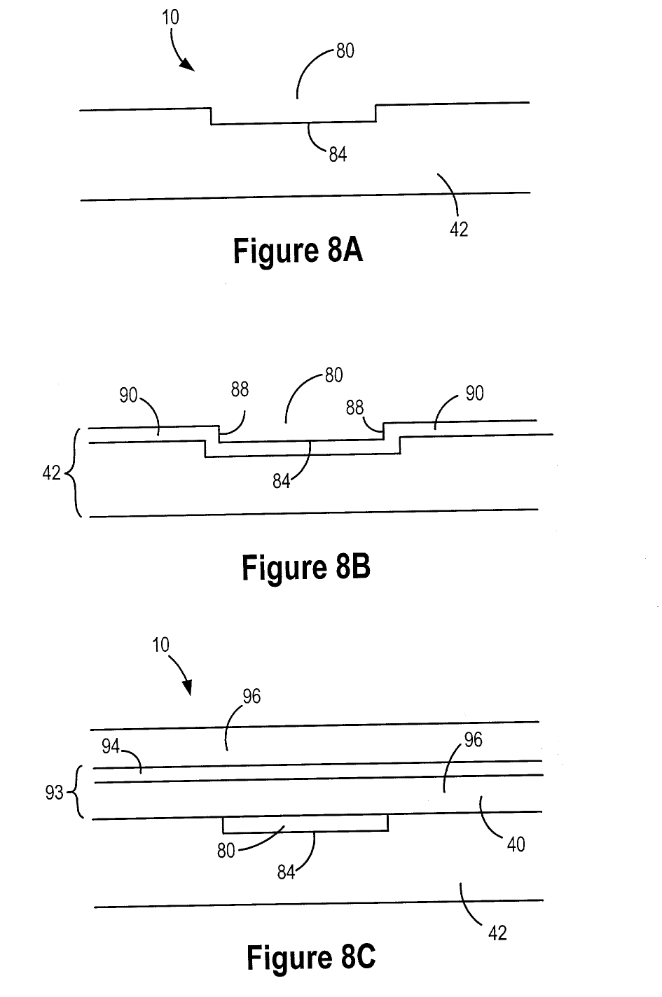

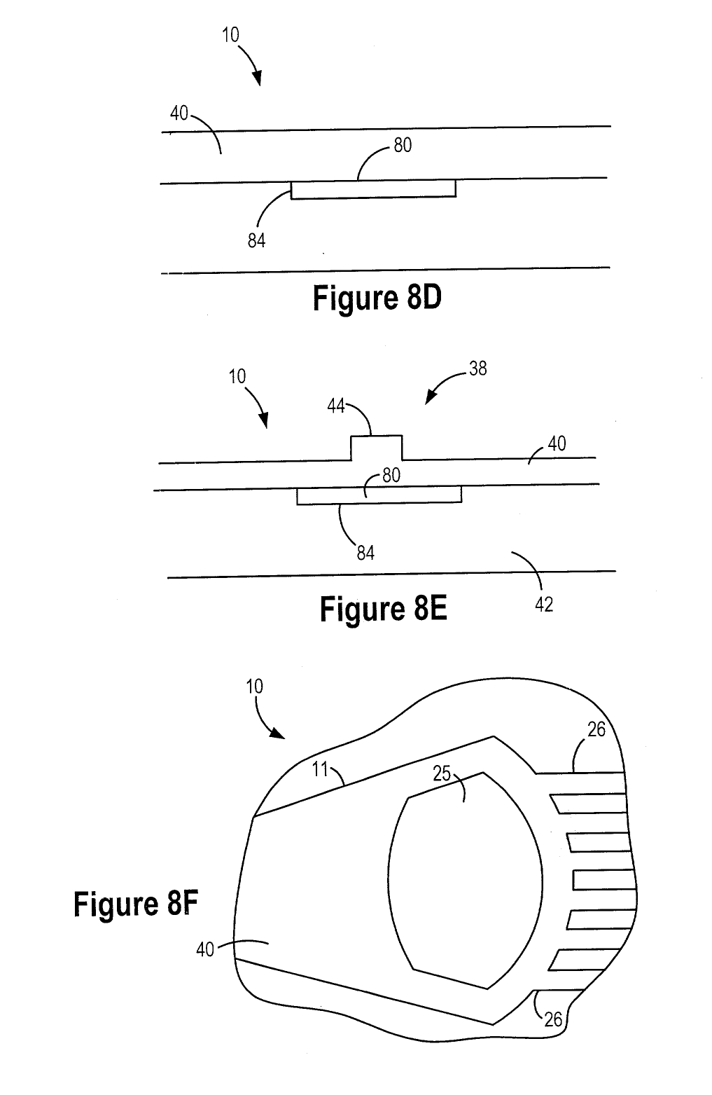

FIG. 8A to FIG. 8F illustrate a method for forming an optical component 10 having an index tuner 25. A mask is formed on a base 42 so the portions of the base 42 where a light barrier 80 is to be formed remain exposed. A suitable base 42 includes, but is not limited to, a silicon substrate. An etch is performed on the masked base 42 to form pockets 84 in the base 42. The pockets 84 are generally formed to the desired thickness of the light barrier 80.

Air can be left in the pockets 84 to serve as the light barrier 80. Alternatively, a light barrier 80 material such as silica or a low K material can be grown or deposited in the pockets 84. The mask is then removed to provide the optical component 10 illustrated in FIG. 8A.

When air is left in the pocket 84, a second light transmitting medium 90 can optionally be deposited or grown over the base 42 as illustrated in FIG. 7B. When air will remain in the pocket 84 to serve as the light barrier 80, the second light transmitting medium 90 is deposited so the second light transmitting medium 90 is positioned adjacent to the sides 88 of the light barrier 80. Alternatively, a light barrier 80 material such as silica can optionally be deposited in the pocket 84 after the second light transmitting medium 90 is deposited or grown.

The remainder of the method is disclosed presuming that the second light transmitting medium 90 is not deposited or grown in the pocket 84 and that air will remain in the pocket 84 to serve as the light barrier 80. A light transmitting medium 40 is formed over the base 42. A suitable technique for forming the light transmitting medium 40 over the base 42 includes, but is not limited to, employing wafer bonding techniques to bond the light transmitting medium 40 to the base 42. A suitable wafer for bonding to the base 42 includes, but is not limited to, a silicon wafer or a silicon on insulator wafer 92.

A silicon on insulator wafer 92 includes a silica layer 94 positioned between silicon layers 96 as shown in FIG. 8C. The top silicon layer 96 and the silica layer 94 can be removed to provide the optical component 10 shown in FIG. 8D. Suitable methods for removing the top silicon layer 96 and the silica layer 94 include, but are not limited to, etching and polishing. The bottom silicon layer 96 remains as the light transmitting medium 40 where the waveguides 38 will be formed. When a silicon wafer is bonded to the base 42, the silicon wafer will serve as the light transmitting medium 40. A portion of the silicon layer 96 can be removed from the top and moving toward the base 42 in order to obtain a light transmitting medium 40 with the desired thickness.

A silicon on insulator wafer can be substituted for the component illustrated in FIG. 8D. The silicon on insulator wafer preferably has a top silicon layer with a thickness that matches the desired thickness of the light transmitting medium 40. The remainder of the method is performed as described below using the silicon on insulator wafer in order to create an optical component 10 having the base 42 shown in FIG. 7A.

The light transmitting medium 40 is masked such that places where a ridge 44 is to be formed are protected. The optical component 10 is then etched to a depth that provides the optical component 10 with ridges 44 of the desired height as shown in FIG. 8E.

The index tuner 25 is formed on the light distribution component 11 as shown in FIG. 8F. When the index tuner 25 includes electrical contacts 54 positioned adjacent to doped regions 56, the doped regions 56 to be formed on the ridge, adjacent to the ridge and/or under the ridge using techniques such as impurity deposition, implantation or impurity diffusion. The electrical contacts 54 can be formed adjacent to the doped regions 56 by depositing a metal layer adjacent to the doped regions 56. The electrical contacts 54 can also be formed without the use of doped regions 56. Any metal layers to be used as temperature control devices can be grown or deposited on the component 36. Doped regions 56 and electrical contacts 54 and/or metal layers can be formed at various points throughout the method and are not necessarily done after the formation of the ridge. Suitable methods for depositing electrical contacts 54 and/or metal layers include, but are not limited to, sputtering, deposition and evaporation.

When the optical component 10 will include a cladding 48, the cladding 48 can be formed at different places in the method. For instance, the cladding 48 can be deposited or grown on the optical component 10 of FIG. 8E.

The etch(es) employed in the method described above can result in formation of a facet and/or in formation of the sides of a ridge 44 of a waveguide. These surfaces are preferably smooth in order to reduce optical losses. Suitable etches for forming these surfaces include, but are not limited to, reactive ion etches, the Bosch process and the methods taught in U.S. patent application Ser. No. 09/690,959; filed on Oct. 16, 2000; entitled “Formation of a Smooth Vertical Surface on an Optical Component” and incorporated herein in its entirety and U.S. patent application Ser. No. 09/845,093; filed on Apr. 27, 2001; entitled “Formation of an Optical Component Having Smooth Sidewalls” and incorporated herein in its entirety.

As noted above, the optical component 10 can be constructed such that the array waveguides 26 include a reflector 50. A suitable method for forming a reflector 50 is taught in U.S. patent application Ser. No. 09/723,757, filed on Nov. 28, 2000, entitled “Formation of a Reflecting Surface on an Optical Component” and incorporated herein in its entirety.

Although the optical component 10 is disclosed in the context of optical components having ridge waveguides, the principles of the present invention can be applied to optical components having other waveguide types. Suitable waveguide types include, but are not limited to, buried channel waveguides and strip waveguide.

Light distribution components 11 constructed as discussed above can also be employed with other optical components. For instances, the above light distribution components 11 can be employed with diffraction gratings. As an example, the light distribution components 11 illustrated in FIG. 4A and FIG. 4B can include reflective a diffraction grating positioned on the output side 22 of the light distribution component 11 in place of the array waveguide grating 24.

Although the above illustrations show the index tuner 25 as being positioned in contact with the light transmitting medium, one or more index layers of material can be positioned between the index tuner 25 and the light transmitting medium. For instance, the thermal energy from a temperature control device can penetrate through one or more cladding layers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical component, comprising:
a light distribution component having a light signal carrying region, the light signal carrying region having an index of refraction; and
an index tuner configured to tune the index of refraction of the light signal carrying region so as to generate a functional region in the light signal carrying region, the functional region being generated such that the index of refraction of the light signal carrying region is different inside of the functional region and outside of the functional region.

2. The component of claim 1, wherein the index tuner is configured to generate the functional region such that a dispersion profile of the light signal changes in response to traveling through the functional region.

3. The component of claim 1, further comprising:
an array waveguide grating having a plurality of array waveguides in optical communication with the light distribution component such that the light signal carrying region extends through the array waveguides, each array waveguide being configured to carry a portion of the light signal.

4. The component of claim 3, wherein at least a portion of the array waveguides are associated with a path through the light distribution component in that a portion of the light signal traveling through an array waveguide also travels along the associated path,
each path through the functional region being associated with a path index j and being adjacent to the index tuner, the length of the portion of the index tuner being positioned adjacent to path j including one or more exponential functions having a base that is a function of the path index, j.

5. The component of claim 4, wherein the exponential function includes β(j+C)^{α}, C, α and β each being constants.

6. The component of claim 4, wherein α is about 2.

7. The component of claim 4, wherein β is positive.

8. The component of claim 4, wherein β is negative.

9. The component of claim 4, wherein α is greater than 2.

10. The component of claim 4, wherein at least a portion of the array waveguides are associated with a path through the light distribution component in that a portion of the light signal traveling through an array waveguide also travels along the associated path,
each path through the functional region being associated with a path index j and being adjacent to the index tuner, the length of the portion of the index tuner positioned adjacent to path j including a linear function of the array waveguide index j.

11. The component of claim 10, wherein the linear function includes j ΔP where ΔL is a constant.

12. The component of claim 1, further comprising:
an array waveguide grating having a plurality of array waveguides in optical communication with the light distribution component such that each array waveguide is configured to carry a portion of the light signal, the array waveguides being arranged so as to combine the portions of the light signal exiting the array waveguides into an output light signal traveling away from the array waveguides at an angle, and
the index tuner being configured such that tuning of the index tuner changes the angle at which the light signals travel away from the array waveguides changes.

13. The component of claim 12, wherein the light distribution component is configured to receive the portions of the light signal from the array waveguides.

14. The component of claim 12, wherein the light distribution component is configured to distribute the portions of the light signal from the array waveguides.

15. The component of claim 1, further comprising:
an array waveguide grating having a plurality of array waveguides in optical communication with the light distribution component such that the light signal carrying region extends through the array waveguides, the light distribution component being an input light distribution component configured to distribute the light signal across the array waveguides of the array waveguide grating.

16. The component of claim 15, further comprising:
an output light distribution component configured to receive the portions of the light signal from the array waveguide and to combine the portions of the light signal into an output light signal directed toward an output side of the second light distribution component.

17. The component of claim 1, farther comprising:
an array waveguide grating having a plurality of array waveguides in optical communication with the light distribution component such that the light signal carrying region extends through the array waveguides, the light distribution component being an output light distribution component positioned to receive a portion of the light signal from each array waveguide and to combine the portions of the light signal into an output light signal directed toward an output side of the light distribution component.

18. The component of claim 17, further comprising:
an input light distribution component configured to distribute the light signal to the array waveguides such that each array waveguide receives a portion of the light signal.

19. The component of claim 1, wherein the light distribution component has a geometry selected from a group consisting of a star coupler and a Rowland circle.

20. The component of claim 1, wherein the index tuner is configured to generate a functional region such that the dispersion profile of the light signal narrows in response to traveling through the functional region.

21. The component of claim 1, wherein the index tuner is configured to generate a functional region such that the dispersion profile of the light signal broadens in response to traveling through the functional region.

22. The component of claim 1, wherein the index tuner is configured to generate a functional region such that the dispersion slope of the light signal increases in response to traveling through the functional region.

23. The component of claim 1, wherein the index tuner is configured to generate a functional region such that the dispersion slope of the light signal decreases in response to traveling through the functional region.

24. The component of claim 1, wherein the index tuner is a temperature control device.

25. The component of claim 24, wherein the index tuner is a resistive heater.

26. The component of claim 1, wherein the index tuner includes a plurality of electrical contacts.

27. The component of claim 26, wherein at least one of the electrical contacts is located adjacent to a doped region.

28. The component of claim 1, wherein the light distribution component is defined in a light transmitting medium positioned on a base.

29. A method of operating an optical component, comprising:
directing a light signal through a light distribution component; and
tuning an index of refraction of a portion of the light distribution component such that a dispersion profile of the light signal changes in response to the light signal being directed through the light distribution component.

30. The method of claim 29, wherein the index of refraction is tuned so as to narrow the dispersion profile of the light signal.

31. The method of claim 29, wherein the index of refraction is tuned so as to change the dispersion slope of the light signal.

32. A method of fabricating an optical component, comprising:
forming a light distribution component in a light transmitting medium positioned on a base, the light distribution component being formed so as to have a light signal carrying region defined in the light transmitting medium, the light signal carrying region having a thickness; and
forming an index tuner adjacent to the light distribution component, the index tuner being configured to tune the index of refraction of a functional region of the light signal carrying region.
